(19) United States
(12) Patent Application Publication
(10) Pub. No.: US 2013/0011651 A1
(43) Pub. Date: Jan. 10, 2013

(54) POLYIMIDE FILM, AND PROCESS FOR PRODUCING POLYIMIDE FILM

(75) Inventors: Nobu Iizumi, Ube-shi (JP); Takao Miyamoto, Ube-Shi (JP); Yohei Higuchi, Ube-shi (JP)

(73) Assignee: UBE INDUSTRIES, LTD., Ube-shi (JP)

(21) Appl. No.: 13/638,179

(22) PCT Filed: Mar. 25, 2011
(86) PCT No.: PCT/JP2011/057469

§ 371 Date: Sep. 28, 2012

(30) Foreign Application Priority Data
Mar. 31, 2010 (JP) 2010-084137
Mar. 31, 2010 (JP) 2010-084553

(51) Int. Cl. C08G 69/26; B29D 7/00; B32B 15/08

(52) U.S. Cl. 428/220; 428/458; 264/216; 528/353

(57) ABSTRACT

The present invention relates to a polyimide film which is obtained by the reaction of a tetracarboxylic acid component and a diamine component and has an orientation anisotropy, in which the variations in the orientation angle in the width direction are within ±10°.

### TECHNICAL FIELD

The present invention relates to a polyimide film having a coefficient of thermal expansion anisotropy between in the MD direction and the TD direction provided by the stretching, in which the coefficient of thermal expansion in the width direction is lower than the coefficient of thermal expansion in the length direction, and having reduced variations in the orientation angle in the width direction, and a process for producing the same.

### BACKGROUND ART

A polyimide film has been widely used in various applications such as the electric/electronic device field and the semiconductor field, because it has excellent heat resistance, chemical resistance, mechanical strength, electric properties, dimensional stability and so on. For example, a polyimide film is used as a base film for a circuit board, a base film for a flexible wiring board, and the like. One example of the suitable polyimide films is a polyimide film prepared from an aromatic tetracarboxylic acid component comprising 3,3′,4,4′-biphenyltetracarboxylic dianhydride as the main component and an aromatic diamine component comprising p-phenylenediamine as the main component (See Patent document 1, for example.).

In general, when a polyimide film is used as a base film as described above, the coefficient of thermal expansion of the polyimide film is desirably controlled to be close to that of a metal laminated thereon. In recent years, however, there is a need for an anisotropic polyimide film having different coefficient of thermal expansions between in the MD direction and the TD direction, in which the coefficient of thermal expansion in the MD direction is close to that of a metal such as copper, and the coefficient of thermal expansion in the TD direction is controlled to be close to that of a chip member such as silicon, or that of a glass plate for liquid crystal, for example, as a base film as described above.

Patent Document 2 discloses a process for producing a polyimide film in which the coefficient of thermal expansion in the width direction is lower than the coefficient of thermal expansion in the length direction, which comprises steps of:

flow-casting a solution of a polyimide precursor in a solvent on a support,

removing the solvent from the solution, to form a self-supporting film;

stretching the self-supporting film in the width direction at an initial heating temperature of from 80° C. to 300° C.; and then heating the film at a final heating temperature of from 350° C. to 580° C.

In the Examples of Patent Document 2, the polyimide films were prepared by stretching the self-supporting films by drawing the fixing members to fix both edges of the films in the width direction at a constant speed and a constant rate during the initial heating, while heating the films under the temperature conditions [1] (105° C.×1 min-150° C.×1 min-280° C.×1 min), or alternatively, the temperature conditions [2] (105° C.×1 min-150° C.×1 min-230° C.×1 min) as the initial heating temperature, and then heating the films at 350° C.×2 min as the final heating temperature without stretching to achieve the completion of imidization.

### CITATION LIST

### Patent Document

Patent document 1: JP-B-H06-002828
Patent document 2: JP-A-2009-067042

### SUMMARY OF INVENTION

### Problems to be Solved by the Invention

However, a conventional production process has low film-forming stability, and a film sometimes becomes cracked during stretching. In addition, the orientation angle tends to deviate from the stretching direction further and further toward the edge of the film. Therefore, a polyimide film produced by the process may exhibit great variations in the orientation angle in the width direction, in particular. The variations in the orientation angle may cause variations in the properties such as coefficient of thermal expansion (CTE) in all directions, including the oblique direction, and elastic modulus, resulting in unevenness of tension during processing/transportation, sagging and unevenness of thermal expansion during heating, slanting warping (including slanting warping in the laminate of polyimide film and another material such as metal), and reduction of dimensional accuracy in processing.

An objective of the present invention is to provide a process for producing stably a polyimide film having a coefficient of thermal expansion anisotropy between in the MD direction and the TD direction, in which the coefficient of thermal expansion in the width direction is lower than the coefficient of thermal expansion in the length direction, by stretching. Another objective of the present invention is to provide a polyimide film having an orientation anisotropy, in which the variations in the orientation angle in the width direction are reduced.

Furthermore, a particular objective of the present invention is to provide a polyimide film which is obtained by the reaction of a tetracarboxylic acid component comprising 3,3′,4,4′-biphenyltetracarboxylic dianhydride as the main component and a diamine component comprising p-phenylenediamine as the main component, and has a coefficient of thermal expansion anisotropy between in the MD direction and the TD direction, in which the coefficient of thermal expansion in the width direction is lower than the coefficient of thermal expansion in the length direction, through the stretching, and has an orientation anisotropy, in which the variations in the orientation angle in the width direction are reduced. Another objective of the present invention is to provide a process for producing such a polyimide film stably.

### Means for Solving the Problems

The present invention relates to the following items.

(1) A process for producing a polyimide film, comprising steps of;

reacting a tetracarboxylic acid component and a diamine component in a solvent, to provide a polyimide precursor solution;

flow-casting the prepared polyimide precursor solution on a support, and drying the solution to form a self-supporting film; and

heating the prepared self-supporting film, to provide a polyimide film;

wherein the self-supporting film is not stretched at a temperature lower than the heat deformation initiation temperature of the self-supporting film; and the self-supporting film is stretched in the width direction at a temperature higher than the heat deformation initiation temperature.

(2) A process for producing a polyimide film as described in (1), wherein the polyimide film has a coefficient of thermal expansion anisotropy between in the length direction (MD direction) and the width direction (TD direction), in which the coefficient of thermal expansion in the TD direction is lower than the coefficient of thermal expansion in the MD direction.

(3) A process for producing a polyimide film as described in any one of (1) to (2), wherein the coefficient of thermal expansion in the TD direction (CTE-TD) and coefficient of thermal expansion in the MD direction (CTE-MD) of the polyimide film satisfy the following inequality:

[(CTE-MD)−(CTE-TD)]>3 ppm/° C.

(4) A process for producing a polyimide film as described in any one of (1) to (3), wherein the self-supporting film is stretched in the temperature range of from the temperature higher by 30° C. than the heat deformation initiation temperature of the self-supporting film to the temperature higher by 120° C. than the heat deformation initiation temperature in at least 25% of the total stretch ratio.

(5) A polyimide film produced by a process as described in any one of (1) to (4).

(6) A polyimide film as described in (5), wherein the polyimide film has an orientation anisotropy, in which the variations in the orientation angle in the width direction are within ±10°.

(7) A polyimide film as described in any one of (5) to (6), wherein the polyimide film has a width of 1000 mm or more.

(8) A polyimide film obtained by the reaction of a tetracarboxylic acid component comprising 3,3′,4,4′-biphenyltetracarboxylic dianhydride as the main component and a diamine component comprising p-phenylenediamine as the main component; wherein the polyimide film has an orientation anisotropy, in which the variations in the orientation angle in the width direction are within ±10°.

(9) A polyimide film as described in (8), wherein the polyimide film has a coefficient of thermal expansion anisotropy between in the length direction (MD direction) and the width direction (TD direction), in which the coefficient of thermal expansion in the TD direction is lower than the coefficient of thermal expansion in the MD direction.

(10) A polyimide film as described in any one of (8) to (9), wherein the polyimide film has a coefficient of thermal expansion in the MD direction (50° C. to 200° C.) of from 10 ppm/° C. to 30 ppm/° C., and a coefficient of thermal expansion in the TD direction (50° C. to 200° C.) of less than 10 ppm/° C.

(11) A polyimide film as described in any one of (8) to (10), wherein the tetracarboxylic acid component comprises 3,3′,4,4′-biphenyltetracarboxylic dianhydride in an amount of 70 mol % or more, and the diamine component comprises p-phenylenediamine in an amount of 70 mol % or more.

(12) A polyimide film as described in any one of (8) to (11), wherein the polyimide film has a width of 1000 mm or more.

### Effect of the Invention

According to the present invention, a polyimide film having a coefficient of thermal expansion anisotropy between in the MD direction and the TD direction, in which the coefficient of thermal expansion in the width direction is lower than the coefficient of thermal expansion in the length direction, may be stably produced by stretching. According to the present invention, a polyimide film having an orientation anisotropy, in which the variations in the orientation angle in the width direction are within ±10°, further within ±5°, further within ±3°, may be produced. According to the present invention, there may be provided a polyimide film which is obtained by the reaction of a tetracarboxylic acid component comprising 3,3′,4,4′-biphenyltetracarboxylic dianhydride as the main component and a diamine component comprising p-phenylenediamine as the main component, and has a coefficient of thermal expansion anisotropy between in the MD direction and the TD direction, in which the coefficient of thermal expansion in the width direction is lower than the coefficient of thermal expansion in the length direction, through the stretching, and has an orientation anisotropy, in which the variations in the orientation angle in the width direction are within ±10°, further within ±5°, further within ±3°. The polyimide film has reduced variations in the orientation angle in the width direction, and therefore has reduced variations in the properties such as coefficient of thermal expansion (CTE) in all directions, including the oblique direction, and elastic modulus, which results in the reductions in unevenness of tension during processing/transportation, sagging and unevenness of thermal expansion during heating, slanting warping (including slanting warping in the laminate of polyimide film and another material such as metal), and loss of dimensional accuracy in processing.

There have been no polyimide films having so small variations in the orientation angle in the width direction. Now such a polyimide film may be prepared by not stretching, or alternatively, shrinking a self-supporting film at a temperature lower than the heat deformation initiation temperature of the self-supporting film, and stretching the self-supporting film in the width direction at a temperature higher than the heat deformation initiation temperature, wherein the self-supporting film (also referred to as “gel-like film”, “gel film”, etc.) is prepared by flow-casting a solution of a polyamic acid as a polyimide precursor on a support to form a film, and heating and drying the solution. More specifically, for the purpose of reducing variations in the orientation angle, the self-supporting film may be preferably most stretched in the width direction in the temperature range of from the temperature higher by 30° C. than the heat deformation initiation temperature of the self-supporting film to the temperature higher by 120° C. than the heat deformation initiation temperature, in addition to being not stretched at a temperature lower than the heat deformation initiation temperature. In the case of polyimide films obtained by the reaction of a tetracarboxylic acid component comprising 3,3′,4,4′-biphenyltetracarboxylic dianhydride as the main component and a diamine component comprising p-phenylenediamine as the main component, the self-supporting film may be particularly preferably most stretched in the width direction at a temperature around 200° C., and more specifically, at a temperature of from 180° C. to 220° C. The stretch ratio may be appropriately selected so as to achieve a desired coefficient of thermal expansion. The self-supporting film may be stretched at any other temperatures, so long as the temperature is higher than the heat deformation initiation temperature.

### BRIEF DESCRIPTION OF THE DRAWINGS

FIG. 1 illustrates the TMA measurement results on the self-supporting film prepared in Example 1.

### DESCRIPTION OF EMBODIMENTS

The polyimide film of the present invention is a polyimide film obtained by the reaction of a tetracarboxylic acid component and a diamine component and having an orientation anisotropy, in which the variations in the orientation angle in the width direction are within ±10°.

According to the present invention, the polyimide film is produced by

the first step of casting a polyimide precursor solution on a support, and forming a self-supporting film from the solution; and

the second step (curing step) of heating the self-supporting film to complete the imidization.

In the second step, the self-supporting film is stretched in the width direction so as to achieve a desired coefficient of thermal expansion. When the temperature at which the self-supporting film is stretched is higher than the heat deformation initiation temperature of the self-supporting film, the variations in the orientation angle in the width direction may be reduced.

A self-supporting film is in a semi-cured state, or in a dried state which is an earlier stage. The term “in a semi-cured state, or in a dried state which is an earlier stage” means that the film is in a self-supporting state by heating and/or chemical imidization. The self-supporting film is any film which may be peeled off from the support, without limitation, and the self-supporting film may have any solvent content (weight loss on heating) and any imidization rate. The solvent content and the imidization rate of the self-supporting film may be appropriately determined depending on the polyimide film intended to be produced.

The polyimide film of the present invention is obtained by the reaction of a tetracarboxylic acid component and a diamine component, particularly by the reaction of a tetracarboxylic acid component comprising 3,3′,4,4′-biphenyltetracarboxylic dianhydride as the main component and a diamine component comprising p-phenylenediamine as the main component, and may be produced by thermal imidization or chemical imidization, or a combination of thermal imidization and chemical imidization.

Examples of the process for producing the polyimide film of the present invention include

(1) a process comprising steps of

flow-casting a polyamic acid solution, or a polyamic acid solution composition which is prepared by adding, as necessary, an imidization catalyst, an organic phosphorous-containing compound, an inorganic fine particle and the like to a polyamic acid solution, on a support to form a film;

heating and drying the solution or the composition to form a self-supporting film; and then

thermally dehydrative cyclizing the polyamic acid and removing the solvent to provide a polyimide film; and

(2) a process comprising steps of

flow-casting a polyamic acid solution composition which is prepared by adding a cyclization catalyst and a dehydrating agent, and, as necessary, an inorganic fine particle and the like to a polyamic acid solution, on a support to form a film;

chemically dehydrative cyclizing the polyamic acid and, as necessary, heating and drying the composition to form a self-supporting film; and then

heating the self-supporting film for removing the solvent and imidizing to provide a polyimide film.

The polyimide film of the present invention may be, for example, produced as follows.

Firstly, a polyamic acid, which is a polyimide precursor, is synthesized by reacting a tetracarboxylic acid component and a diamine component in an organic solvent. And then, the solution of the polyimide precursor thus obtained is flow-cast on a support, after adding an imidization catalyst, an organic phosphorous compound and/or an inorganic fine particle to the solution, if necessary, and heated and dried to form a self-supporting film.

Examples of the tetracarboxylic acid component include aromatic tetracarboxylic dianhydrides, aliphatic tetracarboxylic dianhydrides, and alicyclic tetracarboxylic dianhydrides. Specific examples of the tetracarboxylic acid component include aromatic tetracarboxylic dianhydrides such as 3,3′,4,4′-biphenyltetracarboxylic dianhydride (s-BPDA), pyromellitic dianhydride (PMDA), 3,3′,4,4′-oxydiphthalic dianhydride, diphenyl sulfone-3,4,3′,4′-tetracarboxylic dianhydride, bis(3,4-dicarboxyphenyl)sulfide dianhydride, and 2,2-bis(3,4-dicarboxyphenyl)-1,1,1,3,3,3-hexafluoropropane dianhydride.

Examples of the diamine component include aromatic diamines, aliphatic diamines, and alicyclic diamines. Specific examples of the diamine component include aromatic diamines such as p-phenylenediamine (PPD), 4,4′-diaminodiphenyl ether (DADE), 3,4′-diaminodiphenyl ether, m-tolidine, p-tolidine, 5-amino-2-(p-aminophenyl)benzoxazole, 4,4′-diaminobenzanilide, 1,3-bis(4-aminophenoxy)benzene, 1,4-bis(3-aminophenoxy)benzene, 1,4-bis(4-aminophenoxy)benzene, 3,3′-bis(3-aminophenoxy)biphenyl, 3, 3′-bis(4-aminophenoxy)biphenyl, 4,4′-bis(3-aminophenoxy)biphenyl, 4,4′-bis(4-aminophenoxy)biphenyl, bis[3-(3-aminophenoxy)phenyl]ether, bis[3-(4-aminophenoxy)phenyl]ether, bis[4-(3-aminophenoxy)phenyl]ether, bis[4-(4-aminophenoxy)phenyl]ether, 2,2-bis[3-(3-aminophenoxy)phenyl]propane, 2,2-bis[3-(4-aminophenoxy)phenyl]propane, 2,2-bis[4-(3-aminophenoxy)phenyl]propane, and 2,2-bis[4-(4-aminophenoxy)phenyl]propane.

Examples of the combination of the tetracarboxylic acid component and the diamine component include the following combinations 1) to 3), which may easily provide films having excellent mechanical properties, high rigidity and excellent dimensional stability, and may be suitably used for various substrate, including a substrate for a circuit board.

1) Combination of 3,3′,4,4′-biphenyltetracarboxylic dianhydride, and p-phenylenediamine or, alternatively, p-phenylenediamine and 4,4′-diaminodiphenyl ether (the ratio of PPD/DADE (molar ratio) may be preferably 100/0 to 85/15, for example.).

2) Combination of 3,3′,4,4′-biphenyltetracarboxylic dianhydride and pyromellitic dianhydride (the ratio of s-BPDA/PMDA (molar ratio) may be preferably 99/1 to 0/100, more preferably 97/3 to 70/30, particularly preferably 95/5 to 80/20, for example.), and p-phenylenediamine or, alternatively, p-phenylenediamine and 4,4′-diaminodiphenyl ether (the ratio of PPD/DADE (molar ratio) may be preferably 90/10 to 10/90, for example.).

3) Combination of pyromellitic dianhydride, and p-phenylenediamine and 4,4′-diaminodiphenyl ether (the ratio of PPD/DADE (molar ratio) may be preferably 90/10 to 10/90, for example.).

The combination of the tetracarboxylic acid component and the diamine component may be preferably the combinations 1) or 2), and more preferably the combination 1).

The polyimide precursor to be used in the present invention may be preferably prepared from a tetracarboxylic acid component comprising 3,3′,4,4′-biphenyltetracarboxylic dianhydride (hereinafter, sometimes abbreviated as “s-BPDA”) as the main component, and a diamine component comprising p-phenylenediamine (hereinafter, sometimes abbreviated as “PPD”) as the main component. More specifically, the tetracarboxylic acid component may preferably comprise 70 mol % or more, more preferably 80 mol % or more, particularly preferably 90 mol % or more, further preferably 95 mol % or more of s-BPDA, and the diamine component may preferably comprise 70 mol % or more, more preferably 80 mol % or more, particularly preferably 90 mol % or more, further preferably 95 mol % or more of PPD. The tetracarboxylic acid component and the diamine component as described above may easily provide a film having excellent mechanical properties, high rigidity and excellent dimensional stability, which may be suitably used as various substrate, including a substrate for a circuit board.

In addition to s-BPDA and PPD, other tetracarboxylic acid(s) and other diamine(s) may be used, as long as the characteristics of the present invention would not be impaired.

Specific examples of the aromatic tetracarboxylic acid component to be used together with 3,3′,4,4′-biphenyltetracarboxylic acid component in the present invention include pyromellitic dianhydride, 2,3′,3,4′-biphenyltetracarboxylic dianhydride, 3,3′,4,4′-benzophenone tetracarboxylic dianhydride, 2,2′,3,3′-benzophenone tetracarboxylic dianhydride, 2,2-bis(3,4-dicarboxyphenyl)propane dianhydride, 2,2-bis(2,3-dicarboxyphenyl)propane dianhydride, bis(3,4-dicarboxyphenyl)ether dianhydride, bis(2,3-dicarboxyphenyl)ether dianhydride, 2,3,6,7-naphthalene tetracarboxylic dianhydride, 1,4,5,8-naphthalene tetracarboxylic dianhydride, 1,2,5,6-naphthalene tetracarboxylic dianhydride, 2,2-bis(3,4-dicarboxyphenyl)-1,1,1,3,3,3-hexafluoropropane dianhydride, and 2,2-bis(2,3-dicarboxyphenyl)-1,1,1,3,3,3-hexafluoropropane dianhydride. A tetracarboxylic acid component to be used may be appropriately selected depending on the desired properties, and the like.

Specific examples of the aromatic diamine component to be used together with p-phenylenediamine include m-phenylenediamine, 2,4-diaminotoluene, 2,6-diaminotoluene, 4,4′-diaminodiphenylmethane, 4,4′-diaminodiphenyl ether, 3,4′-diaminodiphenyl ether, 3,3′-dimethyl-4,4′-diaminobiphenyl, 2,2′-dimethyl-4,4′-diaminobiphenyl, 2,2′-bis(trifluoromethyl)-4,4′-diaminobiphenyl, 4,4′-diaminobenzophenone, 3,3′-diaminobenzophenone, 4,4′-bis(4-aminophenyl)sulfide, 4, 4′-diaminodiphenyl sulfone, 4,4′-diaminobenzanilide, 1,4-bis(4-aminophenoxy)benzene, 1,3-bis(4-aminophenoxy)benzene, 1,3-bis(3-aminophenoxy)benzene, 4,4′-bis(4-aminophenoxy)biphenyl, 4,4′-bis(3-aminophenoxy)biphenyl, 2,2-bis(4-aminophenoxyphenyl)propane, bis[4-(4-aminophenoxy)phenyl]sulfone, bis[4-(3-aminophenoxy)phenyl]sulfone, and 2,2-bis[4-(4-aminophenoxy)phenyl]hexafluoropropane. Among others, preferred is a diamine having one or two benzene rings. A diamine component to be used may be appropriately selected depending on the desired properties, and the like.

A polyimide precursor may be synthesized by random-polymerizing or block-polymerizing substantially equimolar amounts of a tetracarboxylic acid component and a diamine component in an organic solvent. Alternatively, two or more polyimide precursors in which either of these two components is excessive may be prepared, and subsequently, these polyimide precursor solutions may be combined and then mixed under the reaction conditions. The polyimide precursor solution thus obtained may be used without any treatment, or alternatively, after removing or adding a solvent, if necessary, to prepare a self-supporting film.

Examples of an organic solvent for the polyimide precursor solution include N-methyl-2-pyrrolidone, N,N-dimethylformamide, N,N-dimethylacetamide and N,N-diethylacetamide. These organic solvents may be used alone or in combination of two or more.

In the case of thermal imidization, the polyimide precursor solution may contain an imidization catalyst, an organic phosphorous-containing compound, an inorganic fine particle, and the like, as necessary.

In the case of chemical imidization, the polyimide precursor solution may contain a cyclization catalyst and a dehydrating agent, and an inorganic fine particle, and the like, as necessary.

Examples of the imidization catalyst include substituted or unsubstituted nitrogen-containing heterocyclic compounds, N-oxide compounds of the nitrogen-containing heterocyclic compounds, substituted or unsubstituted amino acid compounds, and aromatic hydrocarbon compounds or aromatic heterocyclic compounds having a hydroxyl group. Particularly preferable examples of the imidization catalyst include lower-alkyl imidazoles such as 1,2-dimethylimidazole, N-methylimidazole, N-benzyl-2-methylimidazole, 2-methylimidazole, 2-ethyl-4-methylimidazole and 5-methylbenzimidazole; benzimidazoles such as N-benzyl-2-methylimidazole; and substituted pyridines such as isoquinoline, 3,5-dimethylpyridine, 3,4-dimethylpyridine, 2,5-dimethylpyridine, 2,4-dimethylpyridine and 4-n-propylpyridine. The amount of the imidization catalyst to be used is preferably about 0.01 to 2 equivalents, particularly preferably about 0.02 to 1 equivalents relative to the amide acid unit in the polyamide acid. When an imidization catalyst is used, the polyimide film obtained may have improved properties, particularly extension and edge-cracking resistance.

Examples of the organic phosphorous-containing compound include phosphates such as monocaproyl phosphate, monooctyl phosphate, monolauryl phosphate, monomyristyl phosphate, monocetyl phosphate, monostearyl phosphate, triethyleneglycol monotridecyl ether monophosphate, tetraethyleneglycol monolauryl ether monophosphate, diethyleneglycol monostearyl ether monophosphate, dicaproyl phosphate, dioctyl phosphate, dicapryl phosphate, dilauryl phosphate, dimyristyl phosphate, dicetyl phosphate, distearyl phosphate, tetraethyleneglycol mononeopentyl ether diphosphate, triethyleneglycol monotridecyl ether diphosphate, tetraethyleneglycol monolauryl ether diphosphate, and diethyleneglycol monostearyl ether diphosphate; and amine salts of these phosphates. Examples of the amine include ammonia, monomethylamine, monoethylamine, monopropylamine, monobutylamine, dimethylamine, diethylamine, dipropylamine, dibutylamine, trimethylamine, triethylamine, tripropylamine, tributylamine, monoethanolamine, diethanolamine and triethanolamine.

In the case of chemical imidization, examples of the cyclization catalyst include aliphatic tertiary amines such as trimethylamine and triethylenediamine, aromatic tertiary amines such as dimethylaniline, and heterocyclic tertiary amines such as isoquinoline, pyridine, α-picoline and β-picoline. The amount of the cyclization catalyst to be used is preferably 0.1 mole or more per mole of amic acid bond present in the aromatic polyamic acid contained in the solution.

In the case of chemical imidization, examples of the dehydrating agent include aliphatic carboxylic anhydrides such as acetic anhydride, propionic anhydride and butyric anhydride, and aromatic carboxylic anhydrides such as benzoic anhydride. The amount of the dehydrating agent to be used is preferably 0.5 mole or more per mole of amic acid bond present in the aromatic polyamic acid contained in the solution.

Examples of the inorganic fine particle include particulate inorganic oxide powders such as titanium dioxide powder, silicon dioxide (silica) powder, magnesium oxide powder, aluminum oxide (alumina) powder and zinc oxide powder; particulate inorganic nitride powders such as silicon nitride powder and titanium nitride powder; inorganic carbide powders such as silicon carbide powder; and particulate inorganic salt powders such as calcium carbonate powder, calcium sulfate powder and barium sulfate powder. These inorganic fine particles may be used in combination of two or more. These inorganic fine particles may be homogeneously dispersed using the known means.

A self-supporting film of a polyimide precursor solution may be prepared by

flow-casting a solution of a polyimide precursor in an organic solvent as described above, or a polyimide precursor solution composition which is prepared by adding an imidization catalyst, an organic phosphorous-containing compound, an inorganic fine particle, and the like to the solution, on a support; and then

heating the solution or the composition to the extent that a self-supporting film is formed (which means a stage before a common curing process), for example, to the extent that the film may be peeled from the support.

The polyimide precursor solution may preferably contain the polyimide precursor in an amount of from about 10 wt % to about 30 wt %. The polyimide precursor solution may preferably have a polymer concentration of about 8 wt % to about 25 wt %.

In the preparation of a self-supporting film, the heating temperature and the heating time may be appropriately determined. In the case of thermal imidization, a polyimide precursor solution in the form of a film may be heated at a temperature of from 100° C. to 180° C. for about 1 min to 60 min, for example. In the case of chemical imidization, a polyimide precursor solution in the form of a film may be heated at a temperature of from 40° C. to 200° C., for example, until the film becomes self-supporting.

A smooth substrate may be suitably used as the support. A stainless substrate or a stainless belt may be used as the support, for example. An endless substrate such as an endless belt may be suitably used for continuous production.

There are no particular restrictions to the self-supporting film, so long as the solvent is removed from the film and/or the film is imidized to the extent that the film may be peeled from the support. In the case of thermal imidization, it is preferred that a weight loss on heating of a self-supporting film is within a range of 20 wt % to 50 wt %, and it is further preferred that a weight loss on heating of a self-supporting film is within a range of 20 wt % to 50 wt % and an imidization rate of a self-supporting film is within a range of 8% to 55% for the reason that the self-supporting film may have sufficient mechanical properties, and a coupling agent solution may be more evenly and more easily applied to the surface of the self-supporting film, and therefore no foaming, flaws, crazes, cracks and fissures are observed in the polyimide film obtained after imidizing.

The weight loss on heating of a self-supporting film as described above is calculated by the following formula from the weight of the self-supporting film (W1) and the weight of the film after curing (W2).

Weight loss on heating(wt %)={(W1−W2)/W1}×100

The imidization rate of a self-supporting film as described above may be calculated based on the ratio of the vibration band peak area or height measured with an IR spectrometer (ATR) between the self-supporting film and the fully-cured product. The vibration band peak utilized in the procedure may be a symmetric stretching vibration band of an imide carbonyl group and a stretching vibration band of a benzene ring skeleton. The imidization rate may be also determined in accordance with the procedure described in JP-A-H09⁻³¹⁶¹⁹⁹, using a Karl Fischer moisture meter.

According to the present invention, a solution containing a surface treatment agent such as a coupling agent and a chelating agent may be applied to one side or both sides of the self-supporting film thus obtained, if necessary.

Examples of the surface treatment agent include various surface treatment agents that improve adhesiveness or adherence, and include various coupling agents and chelating agents such as a silane-based coupling agent, a borane-based coupling agent, an aluminium-based coupling agent, an aluminium-based chelating agent, a titanate-based coupling agent, a iron-based coupling agent, and a copper-based coupling agent. When using a coupling agent such as a silane coupling agent as a surface treatment agent, the more remarkable effect may be achieved.

Examples of the silane-based coupling agent include epoxysilane-based coupling agents such as γ-glycidoxypropyl trimethoxy silane, γ-glycidoxypropyl diethoxy silane, and 6-(3,4-epoxycyclohexyl)ethyl trimethoxy silane; vinylsilane-based coupling agents such as vinyl trichloro silane, vinyl tris(6-methoxy ethoxy)silane, vinyl triethoxy silane, and vinyl trimethoxy silane; acrylsilane-based coupling agents such as γ-methacryloxypropyl trimethoxy silane; aminosilane-based coupling agents such as N-6-(aminoethyl)-γ-aminopropyl trimethoxy silane, N-6-(aminoethyl)-γ-aminopropylmethyl dimethoxy silane, γ-aminopropyl triethoxy silane, and N-phenyl-γ-aminopropyl trimethoxy silane; γ-mercaptopropyl trimethoxy silane, and γ-chloropropyl trimethoxy silane. Examples of the titanate-based coupling agent include isopropyl triisostearoyl titanate, isopropyl tridecyl benzenesulfonyl titanate, isopropyl tris(dioctyl pyrophosphate) titanate, tetraisopropyl bis(dioctyl phosphate) titanate, tetra(2,2-diallyloxymethyl-1-butyl)bis(di-tridecyl)phosphate titanate, bis(dioctyl pyrophosphate)oxyacetate titanate, bis(dioctyl pyrophosphate)ethylene titanate, isopropyl trioctanoyl titanate, and isopropyl tricumyl phenyl titanate.

The coupling agent may be preferably a silane-based coupling agent, particularly preferably an aminosilane-based coupling agents such as γ-aminopropyl-triethoxy silane, N-β-(aminoethyl)-γ-aminopropyl-triethoxy silane, N-(aminocarbonyl)-γ-aminopropyl triethoxy silane, N-[β-(phenylamino)-ethyl]-γ-aminopropyl triethoxy silane, N-phenyl-γ-aminopropyl triethoxy silane, and N-phenyl-γ-aminopropyl trimethoxy silane. Among them, N-phenyl-γ-aminopropyl trimethoxy silane is particularly preferred.

Examples of the solvent for the solution of a surface treatment agent such as a coupling agent and a chelating agent include those listed as the organic solvent for the polyimide precursor solution (the solvent contained in the self-supporting film). The organic solvent may be a solvent which is compatible with the polyimide precursor solution, or a poor solvent which is not compatible with the polyimide precursor solution. The organic solvent may be a mixture of two or more compounds.

The content of the surface treatment agent (e.g. a coupling agent and a chelating agent) in the organic solvent solution may be preferably 0.5 wt % or more, more preferably 1 wt % to 100 wt %, particularly preferably 3 wt % to 60 wt %, further preferably 5 wt % to 55 wt %. The content of water in the surface treatment agent solution may be preferably 20 wt % or less, more preferably 10 wt % or less, particularly preferably 5 wt % or less. A solution of a surface treatment agent in an organic solvent may preferably have a rotational viscosity (solution viscosity measured with a rotation viscometer at a temperature of 25° C.) of 0.8 to 50,000 centipoise.

A particularly preferable solution of a surface treatment agent in an organic solvent may comprise a surface treatment agent, which is homogeneously dissolved in an amide solvent, in an amount of 0.5 wt % or more, particularly preferably 1 wt % to 60 wt %, further preferably 3 wt % to 55 wt %, and have a low viscosity (specifically, rotational viscosity: 0.8 to 5,000 centipoise).

The amount of the surface treatment agent solution to be applied may be appropriately determined, and may be preferably 1 g/m² to 50 g/m², more preferably 2 g/m² to 30 g/m², particularly preferably 3 g/m² to 20 g/m², for example. The amount of the surface treatment agent solution to be applied to one side may be the same as, or different from the amount of the surface treatment agent solution to be applied to the other side.

The solution of the surface treatment agent may be applied by any known method, including, for example, gravure coating, spin coating, silk screen coating, dip coating, spray coating, bar coating, knife coating, roll coating, blade coating, and die coating.

According to the present invention, the self-supporting film on which a surface treatment agent solution is applied, as necessary, is then subjected to stretching and heat treatment (imidization) to provide a polyimide film.

The temperature profile of the heat treatment for imidization may be appropriately set depending on the desired properties of the polyimide film.

The self-supporting film may be preferably heated gradually, for example, for about 0.05 hr to about 5 hr under the conditions where the highest temperature is within a range of from 200° C. to 600° C., preferably from 350° C. to 550° C., particularly preferably from 400° C. to 500° C. The solvent and the like is sufficiently removed from the self-supporting film, while fully imidizing the polymer constituting the film, such that the polyimide film finally obtained preferably has a volatile content (the amount of the organic solvent, water which has formed, and the like in the film) of 1 wt % or less.

The heating zone may preferably have a temperature gradient, and may comprise a plurality of blocks having various heating temperatures. One example is that the self-supporting film is heated at a relatively low temperature of about 100° C. to about 170° C. for about 0.5 min to about 30 min as the first heat treatment; heated at a temperature of 170° C. to 220° C. for about 0.5 min to about 30 min as the second heat treatment; heated at a high temperature of 220° C. to 400° C. for about 0.5 min to about 30 min as the third heat treatment; and then, as necessary, heated at a high temperature of 400° C. to 600° C. as the fourth high-temperature heat treatment. Another example is that the self-supporting film is heated at a temperature of 80° C. to 240° C. as the first heat treatment; heated at an intermediate heating temperature, as necessary; and then heated at a temperature of 350° C. to 600° C. as the final heat treatment.

The above-mentioned heat treatment may be conducted using any known heating apparatus such as a hot-air oven and an infrared oven. The film may be preferably heated at an initial heating temperature, an intermediate heating temperature and/or a final heating temperature, for example, in an inert gas atmosphere such as nitrogen gas and argon gas or in a heated gas atmosphere such as air.

According to the present invention, the self-supporting film is stretched at least in the width direction (TD direction) at a temperature higher than the heat deformation initiation temperature of the self-supporting film during the heat treatment for imidization. The self-supporting film may be stretched in the length direction (the continuous film-forming direction (machine direction); MD direction), as necessary.

From the common-sense viewpoint, it is assumed that the self-supporting film is started to be heated and stretched simultaneously at a temperature lower than the heat deformation initiation temperature of the self-supporting film so as to prevent orientation relaxation, whereby orienting molecules more readily. Accordingly, it is taken for granted that the self-supporting film is stretched, or started to be stretched at a temperature lower than the heat deformation initiation temperature of the self-supporting film. According to the present invention, however, the self-supporting film is not stretched at a temperature lower than the heat deformation initiation temperature of the self-supporting film and is stretched at a higher temperature, whereby allowing the reduction in the variations in the orientation angle.

The heat deformation initiation temperature of the self-supporting film varies depending on the tetracarboxylic acid component and diamine component constituting the polyamic acid contained therein, solvent content (weight loss on heating) and imidization rate. The temperature at which the self-supporting film is stretched may be any temperature, which is higher than the heat deformation initiation temperature of the self-supporting film. In general, the self-supporting film may be preferably most stretched at a temperature of from the temperature higher by about 20° C. than the heat deformation initiation temperature of the self-supporting film to the temperature higher by about 120° C. than the heat deformation initiation temperature, more preferably from the temperature higher by about 30° C. than the heat deformation initiation temperature to the temperature higher by about 120° C. than the heat deformation initiation temperature, more preferably from the temperature higher by about 40° C. than the heat deformation initiation temperature to the temperature higher by about 100° C. than the heat deformation initiation temperature, particularly preferably from the temperature higher by about 50° C. than the heat deformation initiation temperature to the temperature higher by about 90° C. than the heat deformation initiation temperature. The stretch ratio in the temperature range of from the temperature higher by about 20° C. than the heat deformation initiation temperature of the self-supporting film to the temperature higher by about 120° C. than the heat deformation initiation temperature, particularly preferably from the temperature higher by about 50° C. than the heat deformation initiation temperature to the temperature higher by about 90° C. than the heat deformation initiation temperature, may be preferably 25% or more, more preferably 60% or more, particularly preferably 80% or more, based on the total stretch ratio in the TD direction, or alternatively, in the TD direction and in the MD direction.

The total stretch ratio in the TD direction, or in the TD direction and the MD direction is related to the coefficient of thermal expansion, and therefore may be appropriately selected so as to achieve a desired coefficient of thermal expansion. The total stretch ratio may be, for example, within a range of from 1.01 to 1.6, preferably from 1.05 to 1.5.

For example, the heat deformation initiation temperature of the self-supporting film, which is prepared from a tetracarboxylic acid component comprising 3,3′,4,4′-biphenyltetracarboxylic dianhydride as the main component and a diamine component comprising p-phenylenediamine as the main component, varies depending on the solvent content (weight loss on heating) and the imidization rate, and may be typically around 130° C. The temperature at which the self-supporting film is stretched may be any temperature, which is higher than the heat deformation initiation temperature of the self-supporting film, and may be preferably from 150° C. to 250° C., in general. The self-supporting film may be particularly preferably most stretched at a temperature around 200° C., specifically, at a temperature of from 180° C. to 220° C. The stretch ratio in the temperature range of from 180° C. to 220° C. may be preferably 25% or more, more preferably 60% or more, particularly preferably 80% or more, based on the total stretch ratio in the TD direction, or alternatively, in the TD direction and in the MD direction.

The total stretch ratio in the TD direction, or in the TD direction and the MD direction is related to the coefficient of thermal expansion, and therefore may be appropriately selected so as to achieve a desired coefficient of thermal expansion. The total stretch ratio may be, for example, within a range of from 1.01 to 1.12, preferably from 1.07 to 1.09. Although it is preferred that the self-supporting film is stretched at a temperature of from 180° C. to 220° C., the amount of stretch at each temperature may be appropriately determined.

The “heat deformation initiation temperature of the self-supporting film” is defined as a temperature at which the elongation (%) increases rapidly, which is determined from the elongation (%) versus temperature (° C.) graph, when the elongation (%) is measured by a thermo-mechanical analyzer (TMA) while heating the self-supporting film under the following conditions.
Measurement mode: Tensile mode, load: 4 g,
Sample length: 15 mm,
Sample width: 4 mm,
Temperature-increasing start temperature: 25° C.,
Temperature-increasing end temperature: 500° C., at the discretion (No holding time at 500° C.),
Temperature-increasing rate: 20° C./min,
Measurement atmosphere: Air.

The stretch ratio (total stretch ratio) is defined as follows.

Stretch ratio(%)=(A−B)/B×100

wherein A represents the length in the width direction of the polyimide film produced after stretching, and B represents the length in the width direction of the self-supporting film before stretching.

The stretch ratio (%) in the temperature range of from 180° C. to 220° C. is defined as follows.

Stretch ratio(%) in the temperature range of from 180° C. to 220° C.=(L1−L2)/B×100

wherein L1 represents the length in the width direction of the film at 220° C., L2 represents the length in the width direction of the film at 180° C., and B represents the length in the width direction of the self-supporting film before stretching.

The stretch speed in the width direction may be appropriately selected so as to achieve a desired coefficient of thermal expansion, and may be preferably from 1%/min to 20%/min, more preferably from 1%/min to 10%/min.

As for the pattern of the stretching, the self-supporting film may be instantaneously stretched, or stretched step-by-step, or gradually stretched at a variable rate, or gradually stretched at a constant rate to the desired stretch ratio, or a combination of two or more of these patterns may be also employed. The self-supporting film may be preferably stretched gradually at a constant rate. The rate may be changed between different temperature ranges, for example, between the temperature range of from the temperature higher by about 50° C. than the heat deformation initiation temperature of the self-supporting film to the temperature higher by about 90° C. than the heat deformation initiation temperature (e.g. the temperature range of from 180° C. to 220° C., in the case of the self-supporting film prepared from a tetracarboxylic acid component comprising 3,3′,4,4′-biphenyltetracarboxylic dianhydride as the main component and a diamine component comprising p-phenylenediamine as the main component) and another temperature range.

The heat treatment and the stretching in the second step (curing step) may be preferably conducted by stretching the self-supporting film at least in the width direction, while continuously conveying the film by means of a tentering machine in a curing oven comprising certain heating zones.

Any tentering machine may be used, so long as it may convey the self-supporting film while fixing both edges of the film in the width direction during the heat treatment. A pin tenter having piercing pins as film-fixing members, or a clip tenter and a chuck tenter which fix both edges of the self-supporting film with clips and chucks, respectively, may be used, for example.

The stretch ratio is determined by the ratio of enlargement of the distance between the film-fixing members (piercing pins etc.) to fix both edges of the film in the width direction. In other words, according to the present invention, the amount of enlargement of the distance between the film-fixing members to fix both edges of the film is zero or minus at a temperature lower than the heat deformation initiation temperature of the self-supporting film, and the distance between the film-fixing members is enlarged only at a temperature higher than the heat deformation initiation temperature.

The polyimide film of the present invention may be produced in the form of a long film by the production process as described above. Generally, the both edges of the polyimide film in the width direction, which were fixed by the tentering machine in the stage of self-supporting film, are cut off, and the resulting long polyimide film is wound into a roll and stored until subjected to the subsequent processing.

According to the present invention, there may be provided a long polyimide film having a width of 1000 mm or more, further 1500 mm or more, in which the variations in the orientation angle in the width direction are within ±10°. The upper limit of the width of the film may be appropriately selected depending on the production conditions, and may be preferably 5000 mm or less, particularly preferably 3000 mm or less.

The thickness of the polyimide film may be appropriately selected and may be, but not limited to, 150 μm or less, preferably from 5 μm to 120 μm, more preferably from 6 μm to 50 μm, more preferably from 7 μm to 40 μm, particularly preferably from 8 μm to 35 μm.

A polyimide film produced according to the present invention may be suitably used as a base film for a circuit board, a base film for a flexible wiring board, a base film for a solar cell, and a base film for an organic EL, and particularly suitably used as a base film for a circuit board, and a base film for a flexible wiring board.

A polyimide film which is prepared according to the present invention may have improved adhesiveness, sputtering properties, and metal vapor deposition properties. Therefore, a metal foil such as a copper foil may be attached onto the polyimide film with an adhesive, or alternatively, a metal layer such as a copper layer may be formed on the polyimide film by a metallizing method such as sputtering and metal vapor deposition, to provide a metal-laminated polyimide film such as a copper-laminated polyimide film having excellent adherence and sufficiently high peel strength. A polyimide film which is prepared according to the present invention may be more suitably used for the formation of a metal layer such as a copper layer thereon by a metallizing method such as sputtering and metal vapor deposition, in particular. In addition, a metal foil such as a copper foil may be laminated on a polyimide film which is prepared according to the present invention, using a thermocompression-bondable polymer such as a thermocompression-bondable polyimide, to provide a metal foil-laminated polyimide film. A metal layer may be laminated on a polyimide film by a known method.

The thickness of the copper layer in the copper-laminated polyimide film may be appropriately selected depending on the intended use, and may be preferably from about 1 μm to about 50 μm, more preferably from about 2 μm to about 20 μm.

The type and thickness of the metal foil, which is attached onto the polyimide film with an adhesive, may be appropriately selected depending on the intended use. Specific examples of the metal foil include a rolled copper foil, an electrolytic copper foil, a copper alloy foil, an aluminum foil, a stainless foil, a titanium foil, an iron foil and a nickel foil. The thickness of the metal foil may be preferably from about 1 μm to about 50 μm, more preferably from about 2 μm to about 20 μm.

Another resin film, a metal such as copper, a chip member such as an IC chip, or the like may be attached directly, or via an adhesive onto a polyimide film which is prepared according to the present invention.

Any known adhesive, including an adhesive having excellent insulating properties and excellent adhesion reliability, or an adhesive having excellent conductivity and excellent adhesion reliability such as an ACF, which is bonded by pressure, may be used depending on the intended use. A thermoplastic adhesive or a thermosetting adhesive may be used.

Examples of the adhesive include polyimide adhesives, polyamide adhesives, polyimide-amide adhesives, acrylic adhesives, epoxy adhesives, urethane adhesives, and adhesives containing two or more thereof. An acrylic adhesive, an epoxy adhesive, a urethane adhesive, or a polyimide adhesive may be particularly suitably used.

The metallizing method is a method for forming a metal layer, which is different from metal plating and metal foil lamination, and any known method such as vacuum vapor deposition, sputtering, ion plating and electron-beam evaporation may be employed.

Examples of the metal to be used in the metallizing method include, but not limited to, metals such as copper, nickel, chromium, manganese, aluminum, iron, molybdenum, cobalt, tungsten, vanadium, titanium and tantalum, and alloys thereof, and metal compounds such as oxides and carbides of these metals. The thickness of the metal layer formed by a metallizing method may be appropriately selected depending on the intended use, and may be preferably from 1 nm to 500 nm, more preferably from 5 nm to 200 nm for a practical use. The number of metal layers formed by a metallizing method may be appropriately selected depending on the intended use, and may be one, two, multi such as three or more layers.

A metal-plated layer such as a copper-plated layer and a tin-plated layer may be formed by a known wet plating process such as electrolytic plating and electroless plating on the surface of the metal layer of the metal-laminated polyimide film, which is produced by a metallizing method. The thickness of the metal-plated layer such as a copper-plated layer may be preferably from 1 μm to 40 μm for a practical use.

The polyimide film has a coefficient of thermal expansion in the TD direction (CTE-TD) lower than the coefficient of thermal expansion in the MD direction (CTE-MD). The coefficients of thermal expansion in the TD direction and the MD direction may preferably satisfy the inequality:

[(CTE-MD)−(CTE-TD)]>3 ppm/° C.,

and more preferably satisfy the inequality:

[(CTE-MD)−(CTE-TD)]>5 ppm/° C.,

and further preferably satisfy the inequality:

[(CTE-MD)−(CTE-TD)]>7 ppm/° C.

It is preferred that the polyimide film has a coefficient of thermal expansion in the MD direction which is close to that of a metal to be laminated thereon, and a coefficient of thermal expansion in the TD direction which is close to that of an IC chip such as a silicon chip (about 3 ppm) connected to a wiring which is formed by removing a portion of the metal in the metal-laminated polyimide film, or that of a glass member (about 5 ppm), or the like. The stretch ratio in the TD direction, or in the TD direction and the MD direction, applied to the polyimide film, for example, is controlled so as to achieve a desired coefficient of thermal expansion.

For example, in the case of the copper-laminated polyimide film, it is preferred that the polyimide film has a coefficient of thermal expansion in the MD direction which is close to that of copper, specifically from 10 ppm/° C. to 30 ppm/° C., more preferably from 11 ppm/° C. to 25 ppm/° C., further preferably from 13 ppm/° C. to 20 ppm/° C., and has a coefficient of thermal expansion in the TD direction which is close to that of an IC chip such as a silicon chip, or that of a glass plate (specifically, a glass plate for liquid crystal), specifically less than 10 ppm/° C., more preferably from 0 ppm/° C. to 9 ppm/° C., further preferably from 3 ppm/° C. to 8 ppm/° C.

The “coefficient of thermal expansion” as used herein is a coefficient of thermal expansion (50° C. to 200° C.), which is an average coefficient of thermal expansion (50° C. to 200° C.).

### EXAMPLES

The present invention will be described in more detail below with reference to the Examples. However, the present invention is not limited to these Examples.

### Example 1

Into a polymerization tank were placed the predetermined amount of N,N-dimethylacetamide, and then equimolar amounts of 3,3′,4,4′-biphenyltetracarboxylic dianhydride and p-phenylenediamine. The resulting mixture was mixed, to provide a polyimide precursor solution having a polymer concentration of 18 wt % and a solution viscosity (measurement temperature: 30° C.) of 1800 poise.

The polyimide precursor solution thus obtained was continuously flow-cast from a slit of a T-die mold on a stainless support in the form of endless belt in a drying oven, to form a thin film on the support. The thin film was dried at a temperature of from 120° C. to 140° C., while controlling the temperature and the heating time, to provide a long self-supporting film having a weight loss on heating (solvent content) of 37% and a imidization rate of 15%.

Subsequently, the self-supporting film was fed into a continuous heating oven (curing oven) by means of a tentering machine, while fixing both edges of the film in the width direction with piercing pins. In the curing oven, the film was heated under the conditions of “100° C.×1 min-150° C.×1 min-170° C.×1 min-200° C.×1 min-260° C.×1 min” and, during this heating time, the film was stretched as shown in Table 1 by enlarging the distance between the fixing members to fix both edges of the films in the width direction. In addition, the film was stretched in the temperature range not shown in Table 1 so as to achieve the total stretch ratio as shown in Table 1. Subsequently, the film was heated under the conditions of “500° C.×2 min” without stretching to complete imidization, thereby continuously producing a long polyimide film having an average thickness of 34 μm and a width of 1600 mm.

The variations in the orientation angle of the polyimide film thus obtained were measured as follows. The speed of sound in every direction in the film plane was measured at 31 locations at intervals of 5 cm in the width direction, using “SST-3201” made by NOMURA SHOJI Co., Ltd., and the deviation of the peak angle from the TD direction was determined. The maximum value and the minimum value were defined as the variations in the orientation angle in the width direction. The results are shown in Table 1.

The coefficient of thermal expansion (50° C. to 200° C.) of the polyimide film thus obtained was measured by a thermo-mechanical analyzer (TMA) (compression mode; load: 4 g; sample length: 15 mm; temperature-increasing rate: 20° C./min) after a sample was heated at 300° C. for 30 min for stress relaxation.

With regard to the stability of the pinned (pin-fixed) portion, which is related to the film-forming stability, the enlargement of the hole around the piercing pin at the edge of the film was measured at the outlet of the curing oven for the heat treatment, using “SCOPEMAN® MS-804” made by Moritex Corporation.

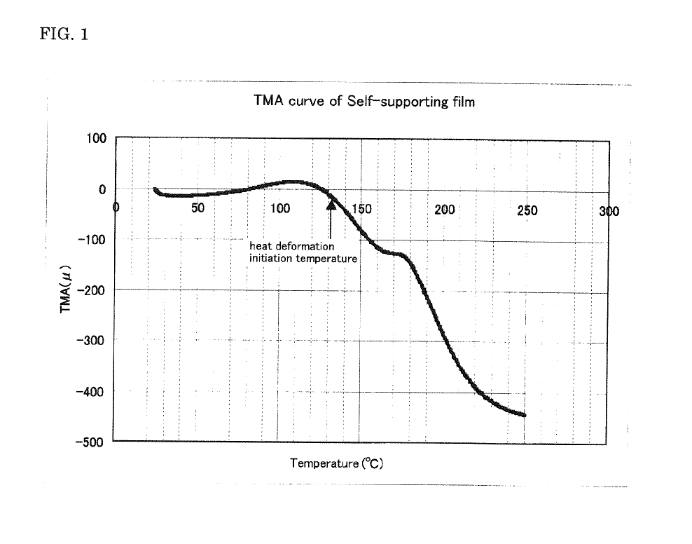

FIG. 1 illustrates the TMA measurement results on the self-supporting film obtained. The heat deformation initiation temperature of the self-supporting film was 130° C.

### Examples 2-3, Comparative Examples 1-3

A long polyimide film was continuously produced in the same way as in Example 1, except that the stretching conditions during the heat treatment of “100° C.×1 min-150° C.×1 min-170° C.×1 min-200° C.×1 min-260° C.×1 min” was changed as shown in Table 1, and the variations in the orientation angle, the enlargement of the hole around the pin, and the coefficient of thermal expansion were determined in the same way as in Example 1. The results are shown in Table 1.

TABLE 1

| | | | | Comparative | Comparative | Comparative |
|---|---|---|---|---|---|---|
| | Example 1 | Example 2 | Example 3 | Example 1 | Example 2 | Example 3 |
| Stretch ratio at a temperature | 0 | 0 | −1 | 3.3 | 2.3 | 1.4 |
| lower than the heat deformation | | | | | | |
| initiation temperature (%) | | | | | | |
| Stretch ratio at a temperature | 3.6 | 3.9 | 4.1 | 0.6 | 0.6 | 1.4 |
| of from 180° C. to 220° C. (%) | | | | | | |
| Total stretch ratio (%) | 5.8 | 6.7 | 7.6 | 4.8 | 5.8 | 5.8 |
| Variations in the orientation | ±5 | ±4 | ±2.5 | ±19 | ±15 | ±12 |
| angle in the width direction (°) | | | | | | |
| Pin hole (mm) | 1.5 | 1.5 | 1.6 | 3.7 | 2.1 | 1.6 |
| Coefficient of thermal expansion | 6.0 | 5.9 | 6.8 | 6.1 | 6.0 | 6.9 |
| in the TD direction (ppm/° C.) | | | | | | |

As can be seen from the Examples and Comparative Examples presented in Table 1, when the self-supporting film is not stretched at a temperature lower than the heat deformation initiation temperature of the self-supporting film and is stretched in the width direction at a temperature higher than the heat deformation initiation temperature, the variations in the orientation angle in the width direction is reduced to within ±5° and the enlargement of the hole around the piercing pin as a film-fixing member is reduced.

The coefficients of thermal expansion in the MD direction of the polyimide films of Examples 1-3 and Comparative Examples 1-3 were about 15 ppm/° C.

### INDUSTRIAL APPLICABILITY

As described above, according to the present invention, the variations in the orientation angle in the width direction may be reduced to within ±10°, further within ±5° in a polyimide film produced by stretching the self-supporting film in the width direction so as to achieve a desired coefficient of thermal expansion. In addition, a polyimide film having an orientation anisotropy caused by stretching may be produced stably and continuously.

According to the present invention, the variations in the orientation angle in the width direction may be reduced to within ±10°, further within ±5° in a polyimide film produced from a tetracarboxylic acid component comprising 3,3′,4,4′-biphenyltetracarboxylic dianhydride as the main component, and a diamine component comprising p-phenylenediamine as the main component, in particular, by stretching the self-supporting film in the width direction so as to achieve a desired coefficient of thermal expansion. In addition, the polyimide film may be produced stably and continuously.

The polyimide film of the present invention may be suitably used as a base film for a circuit board, a base film for a flexible wiring board, and the like.

1-12. (canceled)

13. A polyimide film obtained by the reaction of a tetracarboxylic acid component and a diamine component; wherein the polyimide film has
an orientation anisotropy, in which the variations in the orientation angle in the width direction are within ±10°; and
a coefficient of thermal expansion anisotropy between in the length direction (MD direction) and the width direction (TD direction), in which the coefficient of thermal expansion in the TD direction is lower than the coefficient of thermal expansion in the MD direction.

14. The polyimide film of claim 13, wherein the variations in the orientation angle in the width direction are within ±5°.

15. The polyimide film of claim 13, wherein the tetracarboxylic acid component comprises 3,3′,4,4′-biphenyltetracarboxylic dianhydride as the main component, and the diamine component comprises p-phenylenediamine as the main component.

16. The polyimide film of claim 13, wherein the tetracarboxylic acid component comprises 3,3′,4,4′-biphenyltetracarboxylic dianhydride in an amount of 70 mol % or more, and the diamine component comprises p-phenylenediamine in an amount of 70 mol % or more.

17. The polyimide film of claim 13, wherein the coefficient of thermal expansion in the TD direction (CTE-TD) and coefficient of thermal expansion in the MD direction (CTE-MD) satisfy the following inequality:
[(CTE-MD)−(CTE-TD)]>3 ppm/° C.

18. The polyimide film of claim 13, wherein the coefficient of thermal expansion (50° C. to 200° C.) in the MD direction is from 10 ppm/° C. to 30 ppm/° C., and the coefficient of thermal expansion (50° C. to 200° C.) in the TD direction is less than 10 ppm/° C.

19. The polyimide film of claim 13, wherein the polyimide film has a width of 1000 mm or more.

20. A metal-laminated polyimide film, comprising the polyimide film of claim 13, and a metal foil which is laminated via an adhesive on the polyimide film.

21. A metal-laminated polyimide film, comprising the polyimide film of claim 13, and a metal layer which is formed by a metallizing method on the polyimide film.

22. A process for producing a polyimide film, comprising:
reacting a tetracarboxylic acid component and a diamine component in a solvent to provide a polyimide precursor solution;
flow-casting the polyimide precursor solution on a support, and drying the solution to form a self-supporting film; and
heating the self-supporting film to provide a polyimide film,
wherein the self-supporting film is not stretched at a temperature lower than the heat deformation initiation temperature of the self-supporting film;
the self-supporting film is stretched in the width direction at a temperature higher than the heat deformation initiation temperature of the self-supporting film; and
the self-supporting film is stretched in the temperature range of from the temperature higher by 20° C. than the heat deformation initiation temperature of the self-supporting film to the temperature higher by 120° C. than the heat deformation initiation temperature in at least 25% of the total stretch ratio; wherein
the resulting polyimide film has:
an orientation anisotropy, in which the variations in the orientation angle in the width direction are within ±10°; and
a coefficient of thermal expansion anisotropy between in the length direction (MD direction) and the width direction (TD direction), in which the coefficient of thermal expansion in the TD direction is lower than the coefficient of thermal expansion in the MD direction.

23. The process for producing a polyimide film of claim 22, wherein the self-supporting film is stretched in the temperature range of from the temperature higher by 50° C. than the heat deformation initiation temperature of the self-supporting film to the temperature higher by 90° C. than the heat deformation initiation temperature in at least 25% of the total stretch ratio.

24. The process for producing a polyimide film of claim 22, wherein the self-supporting film is continuously conveyed and heated in a curing oven, while fixing both edges of the film in the width direction with fixing members.

25. The process for producing a polyimide film of claim 24, wherein the fixing members is piercing pins.

26. The process for producing a polyimide film of claim 24, wherein the amount of enlargement of the distance between the fixing members to fix both edges of the self-supporting film in the width direction is zero or minus at a temperature lower than the heat deformation initiation temperature of the self-supporting film.

27. The process for producing a polyimide film of claim 22, wherein the total stretch ratio in the width direction (TD direction) is within a range of from 1.01 to 1.6.

28. The process for producing a polyimide film of claim 22, wherein the coefficient of thermal expansion in the TD direction (CTE-TD) and coefficient of thermal expansion in the MD direction (CTE-MD) of the polyimide film satisfy the following inequality:
[(CTE-MD)−(CTE-TD)]>3 ppm/° C.

29. The process for producing a polyimide film of claim 22, wherein the coefficient of thermal expansion (50° C. to 200° C.) in the MD direction is from 10 ppm/° C. to 30 ppm/° C., and the coefficient of thermal expansion (50° C. to 200° C.) in the TD direction is less than 10 ppm/° C.

30. The process for producing a polyimide film of claim 22, wherein the polyimide film has a width of 1000 mm or more.

31. A polyimide film produced by the process of claim 22.

32. A circuit board comprising the polyimide film of claim 13.

33. A flexible wiring board comprising the polyimide film of claim 13.

34. A solar cell comprising the polyimide film of claim 13.

35. An organic electroluminescent (EL) display comprising the polyimide film of claim 13.
